(19) United States
(12) Patent Application Publication
(10) Pub. No.: US 2022/0391910 A1
(43) Pub. Date: Dec. 8, 2022

(54) ACTION EXECUTION USING DECISION ENGINE SCORES WITH MULTIPLE MERCHANTS

(71) Applicant: HANDLE FINANCIAL, INC., Santa Clara, CA (US)

(72) Inventors: Kurt Torben Thams, Soquel, CA (US); Steven Kramer, Rockaway, NJ (US); John Minor, Freehold, NJ (US); Ernest H. Beernink, San Carlos, CA (US); Stephen Capps, San Carlos, CA (US); John H. Castellucci, San Rafael, CA (US)

(21) Appl. No.: 17/339,905

(22) Filed: Jun. 4, 2021

(51) Int. Cl. G06Q 20/40; G06N 5/04; G06N 5/02; G06F 16/2457; G06F 16/248

(52) U.S. Cl. CPC G06Q 20/4016; G06N 5/045; G06N 5/027; G06F 16/24578; G06F 16/248

(57) ABSTRACT

Actions between a customer and a merchant are guided by decision engine scores using a shared history from multiple merchants. In an example, an action request is received at a service provider. A prime merchant identifier is applied to a merchant database to obtain a policy stack. A customer identifier is applied to a transactions database to obtain a transaction history for the customer and different merchants. Rules of the policy stack are applied in sequence to action parameters and values of the customer transaction history at a decision engine of the service provider, the decision engine generating a first action score. A customer score from the prime merchant is applied to generate a final action score and the prime merchant is notified to conditionally execute the requested action based on the final action score.

### FIELD

The present description relates to executing actions between a customer and a merchant guided by decision engine scores using shared history from multiple merchants.

### BACKGROUND

Merchants seek to reduce the risk in every trade, however, every action entails some risk. While there are systems to estimate the risk of different types of actions, many are too general in that they try to cover every merchant for a very wide range of actions. Other systems are limited to only a small amount of information. Credit scores are sometimes used to generate an estimate of the risk of making a trade with a particular person but credit scores do not provide useful detail and cannot be optimized for particular commercial arenas.

### BRIEF DESCRIPTION OF THE DRAWING FIGURES

The invention may best be understood by referring to the following description and accompanying drawings that are used to illustrate embodiments of the invention. In the drawings:

FIG. 1 is a functional block diagram of interactions with a service provider according to an embodiment of the invention;

FIG. 2 is a block diagram of a portion of a service provider including a decision engine according to an embodiment of the invention;

FIG. 3 is a functional operation diagram of generating an action score according to an embodiment of the invention;

FIG. 4 is a process flow diagram of generating an action score using the decision engine according to an embodiment of the invention;

FIG. 5 is an alternative process flow diagram of generating an action score using the decision engine according to an embodiment of the invention; and

FIG. 6 is a block diagram of a computer system suitable for use as an entity device according to an embodiment of the invention.

### DETAILED DESCRIPTION

Actions between a customer and a merchant are guided by decision engine scores using a shared history from multiple merchants. In an example, an action request is received at a service provider, the action request describes an action between a prime merchant and a customer using action parameters, the parameters including a customer identifier, a prime merchant identifier, and an amount. The prime merchant identifier is applied to a merchant database to obtain a policy stack, the policy stack including a sequence of rules identified with the prime merchant to apply to the action parameters to generate a score. The customer identifier is applied to a transactions database to obtain a transaction history for the customer, the customer transaction history comprising records of transactions between the customer and a plurality of different merchants. Values are extracted from the transaction history for use with the policy stack. The rules are applied in accordance with the sequence of rules to the action parameters and the values of the customer transaction history at a decision engine of the service provider, the decision engine generating a first action score. The customer identifier is applied to the merchant database to obtain a customer score from the prime merchant, the customer score being generated by the prime merchant for the customer. The first action score at the decision engine is adjusted by applying the customer score to the first action score to generate a final action score and the prime merchant is notified of the final action score to conditionally execute the requested action based on the final action score

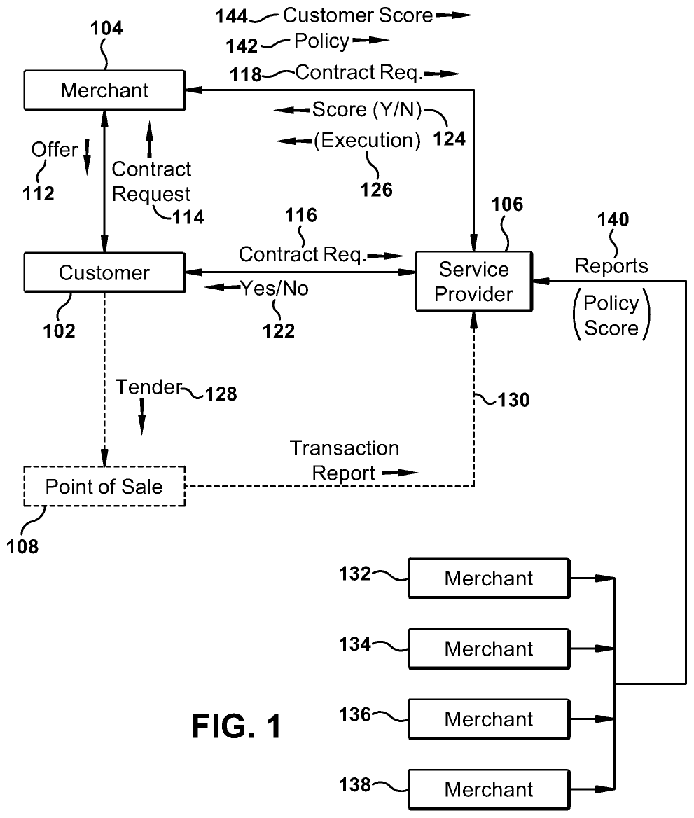

FIG. 1 is a functional block diagram of interactions with a service provider to execute an action between a customer and a prime merchant. A customer 102 connects with a prime merchant to receive offers 112. The offers may be received directly from the merchant or from another party. Alternatively, the customer may make offers to a merchant. In response to an offer, the customer makes a request 114 to execute an action with the merchant. The prime merchant 104 and a service provider 106 receive the request. This operation may be performed in different ways. As shown in this example, the request 114 is sent from the customer to the prime merchant 104 and a form of the request 116 is also sent from the customer to the service provider 106. Alternatively, or in addition, a form of the request 118 may be sent by the prime merchant 104 to the service provider 106. Only one of these three requests is necessary for the service provider to operate a decision engine on the action. The service provider applies this request to a decision engine as described below and then sends a score 122 to the customer or a score 124 to the prime merchant instead of or in addition to the customer. The prime merchant can execute the requested action based on the received final score. Depending on the relationship between the prime merchant and the service provider, the service provider may also execute the action on behalf of the prime merchant and then inform the prime merchant with an action execution notice 126.

The terms customer, merchant, and service provider are used to refer to entities and to roles that each entity plays in the described scenario. Each of these entities include a person or persons, when necessary, and an automated device that includes a data store, a data communications interface, and, in some cases, a user interface as appropriate to performance of the role to support execution of the action. In general, the operations described herein are performed by the devices which have been configured for this purpose. To the extent that it is necessary in this description to specify whether it is a person, device, or some other aspect of the entity then this is specified. In general, the terms customer, merchant, and service provider are used herein to refer to the respective devices within the control of the respective entity.

In the event that the requested action execution receives a positive score from the decision engine, then the customer 102 may perform the customer's side of the action execution through the merchant 104, through the service provider 106 or through another party such as a point-of-sale (POS) terminal 108. In many instances, the customer 102 will provide payment or receive payment. The payment may be provided from the customer's device with a bank or credit transfer or through a point-of-sale terminal 108 with any suitable form of tender 128 including cash. The point-of-sale terminal may be provided by a retailer, a banking institution, or a terminal under the control of the merchant 104 or an entity affiliated with the merchant.

When used, the point-of-sale terminal 108 provides notice 130 of the tender from the POS terminal to the service provider 106 or any other appropriate entity. The merchant 104 performs its side of the of the action execution as is suitable to the action by tendering compensation, credit, goods, services, or any other suitable consideration. In the event that the service provider is aware of the tender from or to the customer having received it directly, or through the point-of-sale terminal 108, then the service provider sends an execution notice 126 to the merchant 104. When the customer interacts directly with the merchant, then the merchant may send a record of the transaction (not shown) to the service provider for records purposes.

In the event of tendering a payment or a disbursement, a variety of different payment channels may be used. For example, the merchant may provide the customer with a “checkout” experience over: a webpage on a merchant's website; an interface on a mobile device; an interactive voice system over a telephone network, such as an IVR (Interactive Voice Response) channel; or any interface or channel equivalent thereto. The user interfaces may provide a “checkout” experience that allows a customer to enter their credit card information or to pay for the goods/services in cash (or cash equivalents). The tender of funds to any particular entity may be made in any suitable manner using any suitable channel.

Direct communications or transfers between individual entities are not required. Presentment and settlement do not require the actual “touching” of funds. Instead, these may include any one or more of transfer funds; direct funds; an interface provided for the transfer of funds; and/or otherwise by the necessary instructions to make sure the funds are properly directed from one entity to another. Further, a transaction (or order), such as presentment, tender, or settlement between the point-of-sale terminal and the merchant-partner may include communications/transfer with any and all centralized or hierarchical entities that receive funds from individual POS terminals and/or POS back offices at the closing of a defined time period (e.g., a banking day).

The service provider has multiple resources available to generate the score 122, 124 to the customer 102 and/or the merchant 104. A first resource is the action request 116, 118 from the customer or merchant or both. The merchant may also send policies 142 for the scoring of action requests and customer scores 144 for the particular customer or for classes of customer. The service provider may apply these policies and scores to a decision engine as described in more detail below.

In some embodiments, the merchant 104 is a part of a community of merchants that share information with the service provider. As shown, there are many other merchants 132, 134, 136, 138, although only four are shown, which provide reports 140 to the service provider and which may also receive reports from the service provider. In some embodiments, the service provider only receives information about actions in which it has participated by receiving requests and rendering scores. In some embodiments, the merchants compile reports that are sent to the service provider on a schedule. In some embodiments, the merchants report each transaction, or each transaction of a particular type to the service provider. In some embodiments, the merchants are part of an association or society of merchants (not shown). The merchants report to the association and the association provides the reports to the service provider. The association may be related to a common industry or common financial group.

The reports may relate to a particular transaction or to particular customers or may include both types of information. The reports may also include policies that are applied by the merchant in generating the reports or in using scores from the service provider. In some embodiments, some of the information provided by the merchants to the service provider is used by the service provider but is not shared with other merchants. The service provider allows each of the merchants to benefit from the knowledge and records of other merchants without being able to see that knowledge and records or reveal its own knowledge and records.

Each of the entities are connected for data communication. The merchants 132, 134, 136, 138, 104 are all coupled to the service provider through a suitable network connection, such as a wide area network, local area network, or any other suitable network. The customer 102 may interact with the merchant 104 directly at a merchant facility, through a computer network, through another merchant, or using a mobile device coupled to a cellular or other wireless network. In some embodiments, the merchant device serves web pages to the customer device and the customer device sends requests to execute actions to the merchant device in response to the web pages.

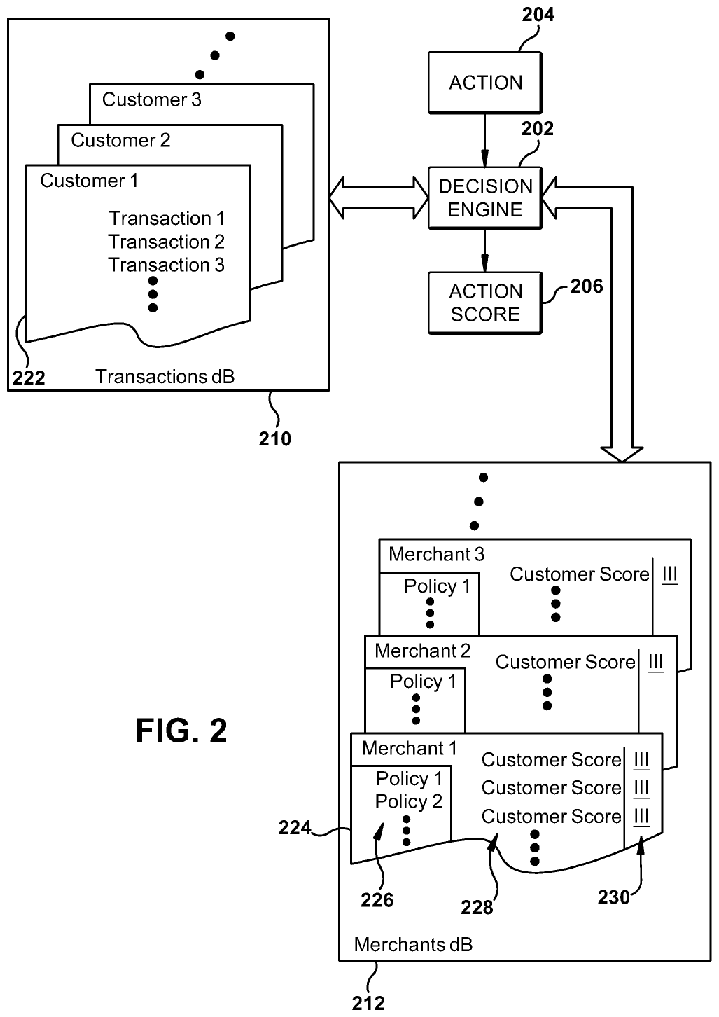

FIG. 2 is a diagram of a portion of a service provider including a decision engine suitable for use in the system of FIG. 1. A decision engine 202 receives the parameters of a requested action 204 between a merchant and a customer. The decision engine 202 generates an action score 206 in response to the request. The decision engine has resources available in terms of at least a transactions database 210 and a merchants database 212. The transactions database 210 has records of transactions. As shown, the transactions are organized into a table 222 for each known customer so that a first table 222 has a record of multiple transactions all performed by the first customer. A second table of the transactions database has a record of multiple transactions for a second customer. There may be many hundreds or thousands of such entries for each customer and tables for each unique customer. While the database is shown and described as being configured as tables in a relational database, any other data structure and database model, such as object-oriented, document oriented, or text string, may be used to suit a particular implementation.

The transaction records for a particular customer may include any values for any parameters relevant to the transaction such as values for parameters such as date, time, customer identifier, customer location, tendered amount, form of tender, location of tender, account numbers used, channel of tender, merchant identifier, and any suitable description of the goods or services involved. The form of tender may include credit, debit, bank accounts, and any customer device or point of service that was used. This information may be organized in tables for each customer, each merchant, or any other field in the table. There may be multiple tables for each transaction or as mentioned above a different data structure or database model may be used.

In some embodiments, the service provider is able to build records and store the records in the transactions database using information from transactions that it processes and from reported transactions. The transactions database can be augmented by processing payments of many customers, each with at least one merchant, and recording the transactions as records that together form a payment history of the customers. A customer of one merchant may be correlated with a customer of another merchant using transaction data, such as device IDs, telephone numbers, e-mail addresses, loyalty program identifiers, credit or payment account information or other transaction data. This data becomes values for different transaction parameters stored in records of the transactions database. Accordingly, records of transactions of a particular customer may be augmented with records of additional transactions that are linked to the same customer based on indicators other than a uniform customer ID. These transaction records may all be associated with the actual customer and be combined to from a fuller picture of the associated customer for use in the decision engine 202.

The merchant database 212 contains information received from the merchants. This information may include the prime merchant and any other merchants. The merchant database has a table 224 for each merchant that includes a policy stack section 226 of rules defining risks and a customer score section 228 relating to particular customers. As with the transactions database 210, more or fewer tables may be used with different organizational structures or the database may have a different data structure or database model.

The risk policies of the merchant database 212 may be used to score a requested action for the merchant. Each merchant table 224 may include multiple policy stacks for different classes of action requests and different classes of customers. As the decision engine 202 receives parameters for the action 204, including the merchant identification, for a particular action request, the decision engine 202 applies the prime merchant identification to the merchants database 212 and retrieves the risk policies for the prime merchant for the action. In some embodiments, additional action parameters are applied to the merchants database to retrieve a particular policy stack of the prime merchant that applies to the action based on amount, type of action, and other criteria. The policy stack represents a policy stack configured by the merchant for particular types of actions. The selected policy stack includes an ordered sequence of one or more rules that is applied to parameters values of the action to determine the action score 206

In embodiments, in the customer section of the merchants database, a high-score customer makes payments timely and in full and has the legal authority to do so. A low-score customer is unreliable in payments or is prevented legally from at least some types of payments. A merchant may use any criteria for scoring the customers and a customer may have different scores for different parameter values, such as types of transactions and forms and channels of payment. A customer may have a high score for low-cost cash transactions and a low score for high-cost credit transactions. Each score for a single customer may have parameter values and ranges. The merchants may agree on a uniform set of parameters and ranges for all scores or the merchants may submit different types of scores in which case the decision engine distinguishes relevant and irrelevant scores. The customer scores reduce the ability of a customer with a low score due to poor behavior at one merchant to repeat the same behavior at another merchant. Similarly, a customer with a high score may be welcomed by all.

The customer section may also include a rules disable matrix section 230 with a rules disable matrix for at least some of the customers. In an embodiment, the matrix may be unpopulated or populated with enable indices initially. The merchant may then selectively disable certain rules of the policy stack for particular customers or classes of customers. Each rules disable matrix has a sequence of indices for each or for certain ones of the policy stacks. Each index selectively enables or disables a rule in a policy stack. As mentioned, each policy stack contains an ordered sequence of rules to be applied to the action parameters. The corresponding sequence of disable indices from the merchant's rules disable matrix is first applied to the rules of a policy stack to disable any one or more of the rules in the stack. Each customer has its own rules disable matrix. For classes of customers, a rules disable matrix may be defined for the class.

In some embodiments, the rules in the policy stack section 226 are not related to any particular customer but instead are tied to other features of the action, such as the nature of the goods or services, location, merchant partners, and other factors. The rules disable matrix allows a merchant to define a unique set of rules for at least some customers. Certain customers may be know as not presenting particular risks and so rules directed to that risk may be disabled. As an example, a customer may be known to travel frequently to other countries. The merchant may disable rules about locations allowing the customer to execute actions from any location.

The merchant database 212 may be generated based on reports received from merchants. The data regarding policies and customers may be modified at any time upon receiving new reports as circumstances change. As an example, a formerly high-risk customer with a bad record, may have exhibited good behavior more recently so that the merchant may be willing to take a higher risk than with a different customer with the same or a similar profile. While the description is presented in terms of reports, the merchant database may be changed in any of a variety of suitable ways. In some embodiments, merchants are provided with a portal that allows access to only that merchant's data. A merchant device may access the service provider device through a restricted portal or other secure and restricted access to modify database values as a push process.

Regardless of how the merchant database 212 is configured, the service provider device may be configured so that each merchant makes its contribution without access to the contributions of any other merchants or with only access to the information that is agreed to be shared. Even though a merchant may not be given permission or access to another merchant's policies or scores, the prime merchant benefits from these when the service provider uses the other merchants scores to generate an action score.

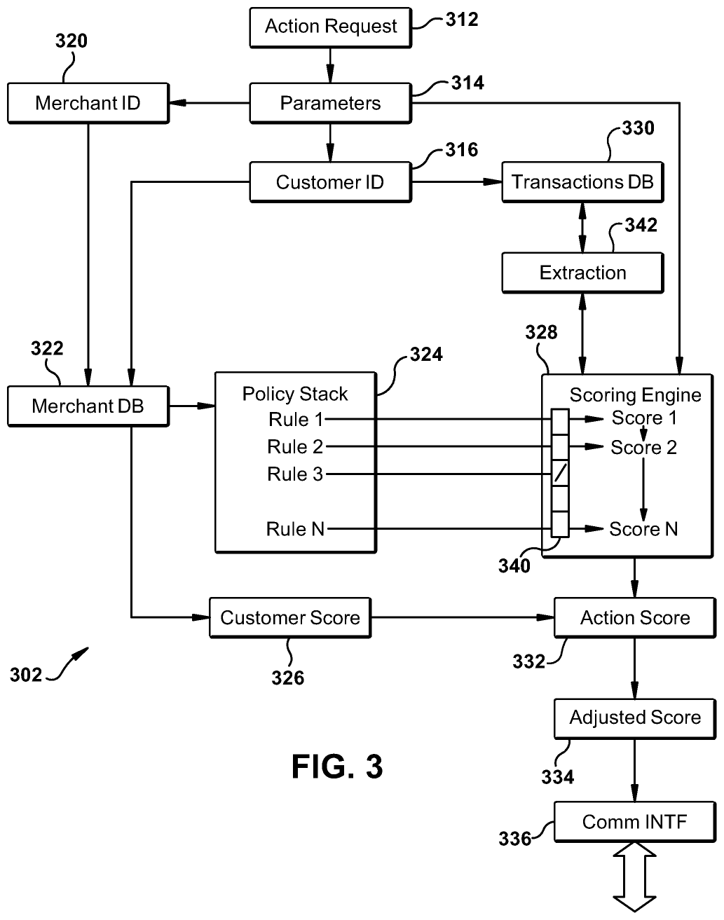

FIG. 3 is a functional operation block diagram of generating a final action score using an action request 204 and the databases 210, 212 of the service provider. The decision engine 302 receives two primary data inputs, the first is the action request 312 which includes parameters 314 such as the customer ID (identifier) 316, the amount, and the payment form 318, among others. A merchant ID 320 may be a parameter of the action or determined in another way such as by the source of the action request 312. The merchant ID 320 is applied to a merchant database 322 to retrieve a policy stack 324. The policy stack 324 is applied to a scoring engine 328. The customer ID 316 is applied to a transactions database 330 to provide transactions data to the scoring engine 328. The policy stack, the action request parameters 314, and the transactions database 330 are used by the scoring engine 328 to generate an action score 332.

As the scoring engine 328 applies rules from the policy stack 324, it is able to extract values from the records of transactions in the transactions database 330. An extraction function 342 of the transactions database responds to requests from the scoring engine to obtain values for parameters of one or more records. Upon extracting the values, they are supplied to the scoring engine. For some rules, multiple values may be extracted to obtain an average, a total, number of transactions within a range of values or dates or other information. The extraction function extracts all of the relevant values and then the scoring engine 328 is able to apply functions to the values based on the rules of the policy stack.

As described herein, applying a parameter or value to a database may be performed in different ways to suit particular applications and data structures. The merchant ID 320 and customer ID 316 values may be configured as addresses to a lookup table or content addressable memory. In other embodiments, the databases are accessed using a search such as a structured query language search. The desired values may be pushed to the policy stack 324 and the scoring engine 328 or the policy stack 324 and the scoring engine may pull any desired values as needed.

The policy stack 324 is filled with a sequence of rules from the merchant database 322. Examples of rules are provided below. Each rule in the sequence of rules is provided to the scoring engine in sequential order. The scoring engine receives the first rule, applies the rule using any necessary parameter and database values, and generates a first interim score. The scoring engine then receives the second rule from the stack and applies the second rule to the first interim score to generate a second interim score. This process continues until the scoring engine has operated on all of the rules for the action request. The result of applying all of the rules is an action score 332. I

In this example, the scoring engine does not receive the third rule. The rules disable matrix 340 is retrieved from the merchant database 322 by applying the merchant ID 320 and the customer ID 316. The rules disable matrix has a sequence of disable indices for the sequence of rules in the retrieved policy stack 324. In the illustrated example, rule 1, rule 2 and rule N are not disabled but rule 3 is disabled in accordance with the value of the index associated with the rule. Because rule 3 is disabled, the action score 332 is not affected by rule 3. The rules disable matrix may suppress any rule in this way for any particular customer.

In some embodiments multiple merchants may choose to use the same policy stack or on merchant may chose to use the policy stack of another merchant. In some embodiments, there may be a default policy stack for use by any merchant that does not provide a unique policy stack. The policy stack obtained by applying the merchant identifier 320 to the merchant database 322 may reflect any such embodiment by mapping the merchant identifier 320 to a group, other merchant, or default policy stack. In some embodiments, the merchant identifier 320 may be mapped to multiple risk policies from different merchants. The multiple risk policies may be provided as sequential sets of rules that are executed in a designated order by the scoring engine.

The merchant ID 320 and the customer ID 314 are also applied to the merchant database 322 to obtain a customer score 326. This customer score is specific to a combination of the merchant ID and the customer ID. In some embodiments, the merchant's customer score is not based on a specific single customer but a customer group as defined by relationships or characteristics. The customer score 326 is applied to the action score 332 to adjust the action score. The customer score may be applied by the scoring engine 328 or another device. This generates an adjusted score 334. The adjusted score is tailored specifically to the desires of the requesting merchant and is sent to that merchant through a communications interface 336. The score may be rendered as a binary, e.g., yes/no, ternary, e.g., red/yellow/green, decimal, e.g., 1-10, or any desired resolution on a scale configured by the merchant.

The customer score may be a value that is combined by addition or multiplied as a factor. In some embodiments probabilistic scoring is preferred. With probabilistic scoring, a 0 will always result in “no” but a 1 can still be counteracted by low scores like 0. Customer scores may be either favorable or unfavorable, so both positive and negative scores may be used by a merchant. The “yes” and “no” binary result may be provided as a score that is very low. As an example, a “bad actor” score (−1000) may be used by a merchant to outweigh or factor out any positives from the action score.

In some embodiments, the merchant may prefer to rely on a customer score from another merchant. If so, then the customer score 326 from the merchant database 322 may be from a different merchant than the prime merchant identified in the action request 312 parameters. In some embodiments, the prime merchant may wish to use its own customer score and also the customer score of another merchant. The other reporting merchant customer score may be used by adjusting the first action score by applying a first customer score from the prime merchant and a second customer score from the other reporting merchant. The scores may be applied in any order. Customer scores of more reporting merchants may be used to obtain a fuller picture or to ensure that the action score is accurate. In some embodiments, many of the reporting merchants, including the prime merchant may not have a score for many possible customers. By using customer scores of other merchants, a customer score is more likely to be found. When the service provider notifies the prime merchant only of the final adjusted score 334 without showing the first action score 332, then each merchant's customer score 326 may be hidden from each other merchant.

The merchant receives the adjusted score and then alternately executes or does not execute the requested action based on the received score. If the score is to approve the action or if the score is higher than some threshold, then the action is executed. If the score is to reject the action or is lower than some threshold, then the action is not executed. The execution of the action is conditional on the final action score. In some embodiments, a service provider operates the decision engine and executes a part of the action on behalf of the merchant or sends instructions to another entity, for example a point-of-sale terminal to execute a part of the action. Upon execution of the action or upon scoring the action for execution, the service provider may store the action as a record to the transactions database. When the service provider performs a part of the action, then data about the performance may be used to further add to the record that is stored in the transactions database about the action.

In the present description, the decision engine is described as operating by applying rules to values that are extracted from a transactions database. An action may be scored using different techniques and structures than those described. In an alternative embodiment, the final action score is obtained using an artificial intelligence engine. Different merchants may use different training data or interpret the results differently from each other. In another alternative, cost functions may be applied to determine a lowest cost result instead of at least some of the rules. In another alternative embodiment, statistical techniques may be applied to rank the requested action with respect to other comparable actions.

The policies may be provided in the form of rules. Such a rule invokes one or more parameters and applies a function to the values of the parameters to determine a result. The result may be a numerical result or a binary result such as yes/no, pass/fail, etc. An example may be as follows:

if R<3, then reduce score 50 points;

if R>2, then score is no

In this example, R may relate to repossessions or missed payments or another parameter relevant to action execution. The result is to adjust the score based on the values of R. Two rules are used to implement a policy against bad risks. By using data from multiple merchants, the parameter value may be higher than with one merchant alone providing a clearer picture of the customer.

Another rule may be applied by the merchant based on type of action or the customer. For the action a rule may be:

if TO=itemD and location radius <50 miles, then score is yes

In this example, the parameter TO may refer to the object of the transaction and itemD may refer to an item which is the object of the transaction. Location radius may refer to the distance between the customer and the merchant. This rule is compound and means that any local customer may conduct this transaction regardless of the customer's score. The transaction for itemD may be one for which the merchant is not concerned about risk for local customers.

Another type of rule may establish ranges and then adjust scores in response. Such rules may be expressed as:

if aggregate customer score >2000, then score is yes

if aggregate customer score <2000 and >1000, then reduce score by 300

if aggregate customer score <1000, then reduce score by 500

This rule sequence applies a reduced tolerance for low scores and the score may be lower when the aggregate customer score from all merchants is combined. Such a merchant policy may be combined with any one or more other rules to balance decisions based on any parameters that are available. In some embodiments, missing values for some parameters, such as when information is not available, may be used to reject a customer or adjust a score. The values may be in the form of individual parameters about an individual customer, or aggregated parameters about multiple customers. In some embodiments as here, the rules are configured to reflect preferences such as thresholds that the merchant applies to the decision.

The decision engine of FIG. 3 may also apply policies that a merchant may value for particular types of risks using the information available in the transactions database. A threshold may be configured for a value related to the number of credit accounts used by a customer or the location of the customer compared to the address for the credit account or the names used by the customer compared to the name used on the credit accounts. The values of these and other parameters may be compared using rules like those above to make a risk assessment configured for any particular merchant.

A useful system will be able to provide a score quickly enough not to impede the action and quick enough not to deter the customer. The configuration of FIG. 3 allows for a very large amount of data to be made available and yet for the decision engine to acquire exactly the desired data very quickly. In addition, the policy stack allows for a very precisely tailored score to be generated with speed. Accordingly, the described configuration is able to provide great speed with just the results that a particular merchant wants for a particular type of action. In some embodiments, billers can automate their ideal bill payments process to mitigate risk, decrease operations expenses and drive ideal customer payment behaviors. Using logic-based rules and custom scores, billers can tailor the agent and customer experience to fit their unique needs. In some embodiments, billers can remove an ACH (Automated Clearing House) oprtion and force a cash or debit pay if the customer has too many prior NSFs (Non-Sufficient Funds).

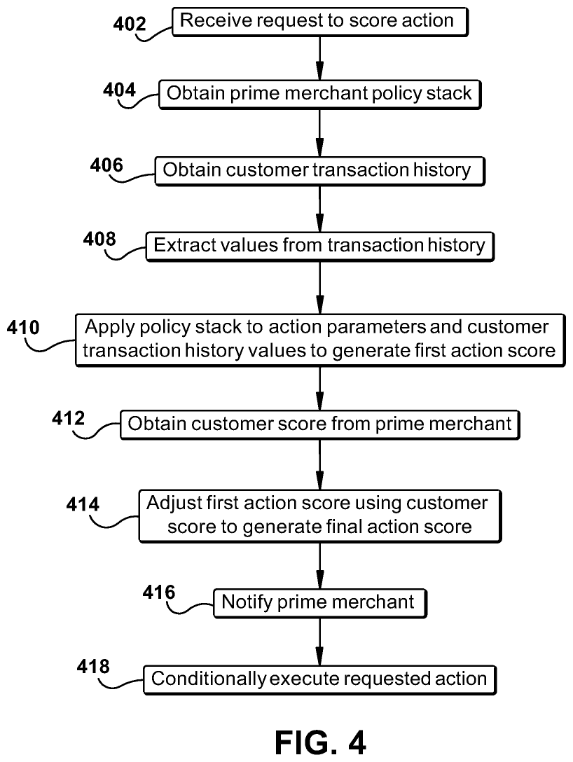

FIG. 4 is a process flow diagram for a generalized process of generating an action score as described above. At 402, a request is received to score a proposed action. At 404 the parameters that are included with or associated with the request, such as a source address or header, are used to obtain a policy stack for use in scoring the proposed action. This policy stack may be particular to the prime merchant that requested the action score, but may be a policy stack for a group or class or merchants. At 406 the parameters that are included or associated with the request are used to obtain transaction history for the customer.

In the described examples, the two parties to the action are referred to as merchant and customer for convenience, but the merchant may be buying or selling goods or services so that in some cases, the customer may also be buying or selling goods or services in which case, the customer is also a merchant for the goods or services. In the example herein, the distinction between prime merchant and customer is that the prime merchant is requesting the score to use in conditionally executing the proposed action. The customer is not requesting the score. However, the same or similar process described here on behalf of the prime merchant may also be performed on behalf of the customer for use by the customer in scoring the proposed action.

At 408 values are extracted from the customer transaction history in order to supply value to the policy stack. At 410 the policy stack is applied to the parameters of the action and the customer transaction history values to generate a first action score. As described above, the policy stack may be in the form of a sequence of logical rules, such as if, then statements, functional operations such as compare or threshold operations, or other rules. In some embodiments, rules that do not depend on each other may be applied in parallel. In some embodiments, the policy stack may be in the form a machine learning process driven by an artificial intelligence engine to recognize actions with high or low risk or in any other suitable form.

At 410 a customer score is obtained and at 412 the customer score is used to adjust the first contract score and generate a final action score. The customer score may be generated by the merchant or by another entity and associated for use by the prime merchant. The customer score allows the merchant or another entity to adjust the score to accommodate unique characteristics of or relationships with the customer or a class of customers that is not reflected in the policy stack. At 416 the prime merchant is notified and at 418, the prime merchant is able to execute the requested action conditional on the final action score result.

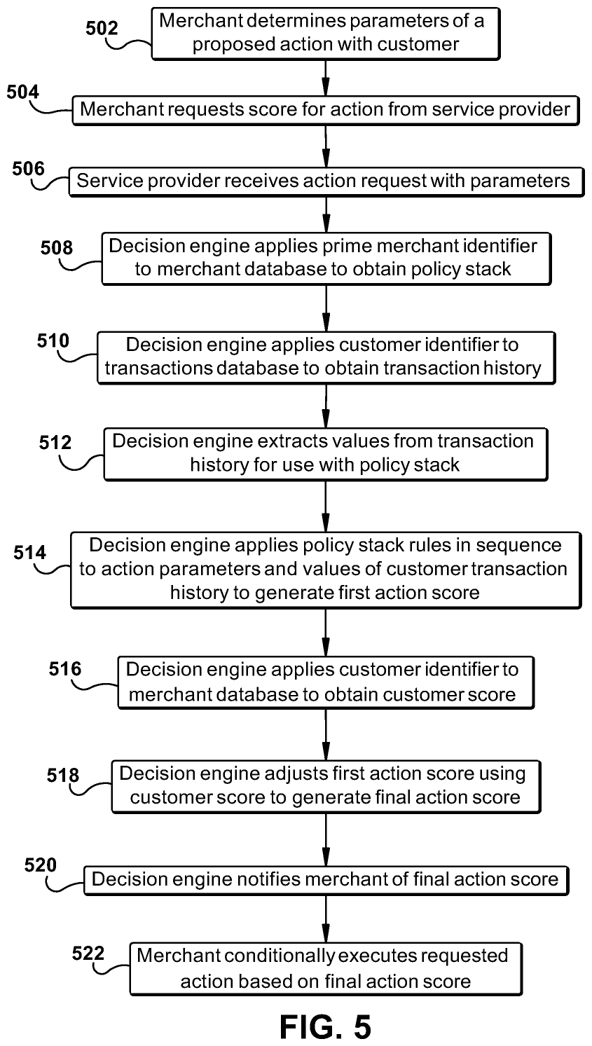

FIG. 5 is a more specific process flow diagram for generating an action score. The process is initiated by a merchant, referred to as the prime merchant that seeks to execute some action with a customer. The actions between the customer and the merchant are guided by decision engine scores using a shared history from multiple merchants. In FIG. 5, the merchant makes an offer to a customer or vice versa and the parameters of an action are determined at 502. These parameters may include a customer identifier, a prime merchant identifier, an amount and may include many other parameters such as times, places forms and channels of payment, and more. The merchant sends a request to score the offer to a service provider at 504. The request includes the parameters or an indicator that the service provider may use to determine the parameters. The parameters may be encoded, or identified with an index to a list or database of possible actions. The code or index may be combined with the merchant's identity or source address or other indicator to aid in determining the parameters of the action.

The action request is received at a service provider at 506. The action request describes or in some way indicates the action between the prime merchant and the customer that is to be scored. At 508 a prime merchant identifier is applied to a merchant database to obtain a policy stack. The policy stack includes a sequence of rules identified with the prime merchant to apply to the action parameters to generate a score. At 510 a customer identifier is applied to a transactions database to obtain a transaction history for the customer, the customer transaction history may include a table of transaction records between the customer and a plurality of different merchants or the data may be aggregated from multiple tables or other data structures. The transactions records may include values for amount, form or payment, channel of payment parties to the transaction, ratings as successful or unsuccessful and other parameters. The transactions database may be made particularly valuable to the merchant by having information supplied or reported by other merchants. This allows the merchant to benefit from the experience of other merchants. The merchant database and the transaction database may be configured as content addressable memories so that applying the prime merchant identifier or customer identifier includes applying the identifier as content to obtain the data from the content addressable memory. At 512 values are extracted from the transaction history for use with the policy stack.

The policy stack is in the form of a sequence of rules. The rules are arranged as a sequence so that each rule is executed in series and an intermediate score is generated after the execution of each rule. The sequence is a part of the policy stack. At 514, the decision engine at the service provider applies the rules in accordance with the sequence of rules to the action parameters and the values of the customer transaction history. These operations result in the decision engine generating a first action score.

The first action score is then adjusted for the prime merchant. At 516, the decision engine applies the customer identifier to the merchant database to obtain a customer score from the prime merchant. The customer score is generated by the prime merchant for the customer that is a part of the action. The first action score at the decision engine is then adjusted at 518 by applying the customer score to the first action score to generate a final action score.

At 520, the decision engine notifies the prime merchant of the final action score and at 522, the merchant conditionally executes the requested action based on the final action score. The final action score may be a simple yes/no, approve/disapprove, or similar binary choice. The configuration of the policy stack may be used to determine the nature of the score. In some embodiments, the final action score may have many levels, e.g., 3, 10, or more and the merchant may apply other criteria to make the decision whether to execute the action with the customer. As an example, if a merchant has low number of recent actions, it may accept a lower score in order to increase the total number of actions.

As described above, the merchant may also have a sequence of disable indicators for its rules. There may be multiple sequences of disable indicators, each for a different policy stack so that the indices form a rules disable matrix. When the service provider obtains the appropriate policy stack, it may also retrieve a sequence of disable indices associated with a particular customer that is configured to be applied to the sequence of rules. The sequence of indices allows the merchant to disable certain ones of the rules for particular customers. In such embodiments, the operations at 514 includes applying the associated index to each rule to conditionally disable the associated rule. As a result, for some customers, one or more of the rules are disabled and are not used in generating the first action score.

The described system and operations allow merchants to share the use of their information about customers with other merchants without allowing the other merchants to see the information. Additional customer information may be provided by the service provider using transactions that are not available to any of the merchants in the group. While merchants may wish to cooperate to avoid risky customers, data about transactions with those customers may contain trade secret information about prices, numbers of transactions, times and places of transactions and the mix of customers. The service provider is able to use this information that is freely reported by the merchants without any merchant seeing the information.

When a merchant tries to assess information from another merchants, the information may not be configured, stored, or managed in a useful way. The described system and operations allow each merchant to configure its own policies for its own transactions. Different types of transactions may be scored differently using different criteria. The policy stacks allow each merchant to apply raw transactions data to generate a decision on its own terms. This is a substantial advantage over credit score systems that try to use uniform criteria to create single numerical score that can be used by all merchants.

Even when a merchant configures its own policy stack to apply to particular actions and customers, such a system takes away the meaning of a personal relationship with or deeper knowledge of a customer. The described system and operations allow a merchant to adjust the scores of individual customers up or down based on that personal relationship or deeper knowledge. The rules disable matrix provides yet another avenue to accommodating unique factors for a particular customer.

The above features in combination allow a merchant to receive a score that is uniquely suited to a particular merchant, action, and customer at a particular time. Actions can be performed faster, risk is lower, and fewer action opportunities are missed by an overabundance of caution. More customer can be accepted in less time. Each merchant receives the scores that it wants even though it shares information with other merchants. All the time transaction information, policies and action details can all be kept secret from other merchants.

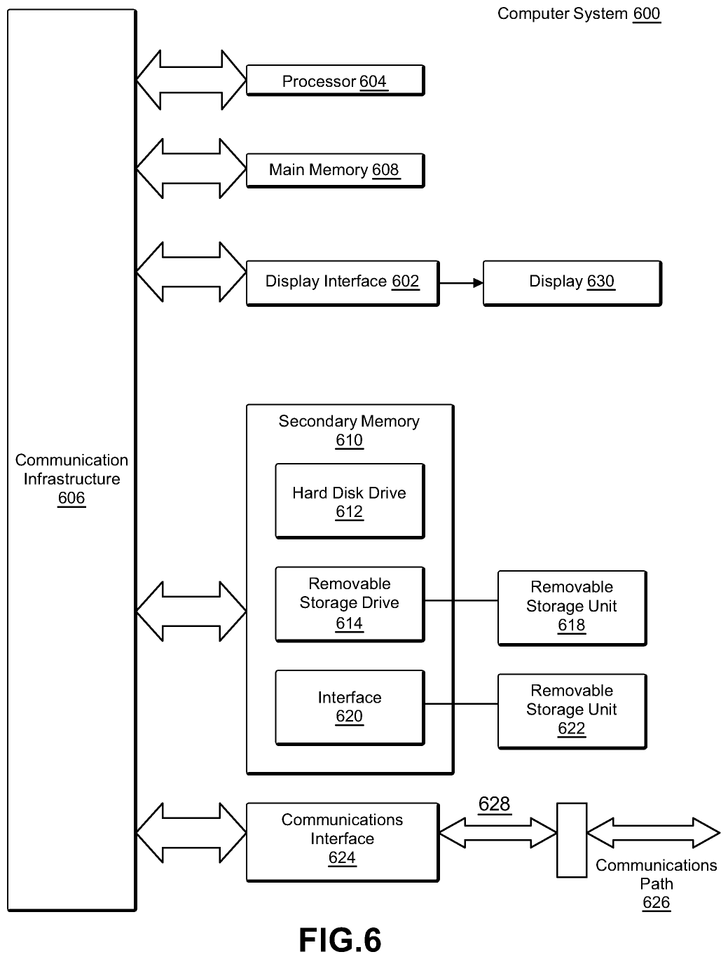

FIG. 6 is a block diagram of computer system suitable for use as the merchant device, customer device, and service provider device as described herein. The computer system 600 includes one or more processors, such as processor 604. The processor 604 is connected to a communication bus 606 (e.g., a communications bus, cross-over bar, or network). The computer system 600 can include a display interface 602 that forwards graphics, text, and other data from the communication bus 606 (or from a frame buffer not shown) for display on a local or remote display unit 63 and that receives touch screen or other user input device commands (e.g., microphone, keypad, mouse, stylus, accelerometers, etc.) for control of the computer system's operations.

The computer system 600 also includes a main memory 608, such as a random-access memory (RAM), and may also include a secondary memory 610. The secondary memory 610 may include, for example, a hard disk drive 612 or suitable solid state or magnetic equivalents, and/or a removable storage drive 614, representing a disk drive, a tape drive, an optical drive, flash memory device, etc. The removable storage drive 614 reads from and/or writes to a removable storage unit 618. Removable storage unit 618 represents a floppy disk, magnetic tape, optical disk, flash memory device, etc., which is read by and written to by removable storage drive 614. As will be appreciated, the hard disk drive 612 and removable storage unit 618 each include a computer-readable storage medium having stored thereon computer software, instructions, and/or data.

In alternative embodiments, the secondary memory 610 may include other similar devices for allowing computer programs or other instructions to be loaded into the computer system 600. Such devices may include, for example, a removable or attached storage unit 622 and an interface 620. Examples of removable media include socketed non-volatile RAM, a removable memory chip (such as an erasable programmable read only memory (EPROM), or programmable read only memory (PROM)) and associated socket, and other removable storage units 622 and interfaces 620, which allow computer software, instructions, and/or data to be transferred from the removable storage unit 622 to the computer system 600. Attached storage may be connected through wired or wireless interfaces that are dedicated to the computer system 600 or shared between multiple such systems.

The computer system 600 includes a communications interface 624 that allows computer software, instructions, and/or data to be transferred between the computer system 600 and external devices. Examples of the communications interface 624 include a modem, a network interface (such as an Ethernet card), a communications port, wireless network interfaces such as Wi-Fi or cellular, etc. Software and data transferred via the communications interface 624 are in the form of signals 628 which may be electronic, electromagnetic, optical, or other signals capable of being received by the communications interface 624. These signals 628 are provided to the communications interface 624 via a communications path (e.g., channel) 626. This channel 626 carries signals 628 and may be implemented using wire or cable, fiber optics, a telephone line, a cellular link, a radio frequency (RF) link, a wireless communication link, and other communications channels. Communications interface 624 may be implemented using custom or proprietary protocols and hardware or using various standards-based protocols and related hardware, such as Universal Serial Bus (USB) protocols, IEEE 1394 standards-based protocols, or other protocols for data transfer.

Computer programs (also referred to as computer control logic) are stored in the main memory 608 and/or the secondary memory 610. The computer programs may also be received via the communications interface 624. Such computer programs, when executed, enable the computer system 600 to perform the features of the various embodiments, as discussed herein. In particular, the computer programs, when executed, enable the processor 604 to perform the features of the presented methods. Accordingly, such computer programs represent controllers of the computer system 600. Where appropriate, the processor 604, associated components, and equivalent systems and sub-systems thus serve as “means for” performing selected operations and functions. Such “means for” performing selected operations and functions also serve to transform a general-purpose computer into a special purpose computer programmed to perform said selected operations and functions.

In an embodiment where the invention is implemented using software, the software may be stored in a computer program product and loaded into the computer system 600 using the removable storage drive 614, the interface 620, the hard drive 612, or the communications interface 624. The control logic (software), when executed by the processor 604, causes the processor 604 to perform the functions and methods described herein.

Some embodiments include applying the customer identifier to the merchant database to obtain a sequence of indices for the sequence of rules and wherein applying the rules comprises applying an associated index to each rule to conditionally disable the associated rules.

In some embodiments, the merchant database is configured as a content addressable memory and wherein applying the prime merchant identifier comprises applying the prime merchant identifier as content to obtain the policy stack from the content addressable memory. In some embodiments, the records of transactions comprise an amount, a form of payment, parties to the transaction, and a rating as successful or unsuccessful. In some embodiments, the transactions database comprises records generated from reports of transactions from reporting merchants other than the prime merchant. In some embodiments, the action parameters further comprise a form of payment, wherein retrieving the policy stack comprises retrieving a policy stack for the form of payment of the action.

In some embodiments, the customer score is associated only with the customer. In some embodiments, the customer score is associated with a class of customers. In some embodiments, the final action score has either a first value to approve the action or a second value to reject the action. Some embodiments include alternately executing or not executing the action between the customer and the merchant by the service provider in response to the final action score.

Some embodiments include storing the action as a record in the transactions database. Some embodiments include augmenting the transactions database by processing payments of a plurality of customers, each with at least one merchant, and recording a payment history of the plurality of customers. Some embodiments include augmenting the transactions database by correlating transaction data to associate transactions with individual customers. Some embodiments include receiving a second customer score from a reporting merchant and wherein adjusting the first action score comprises adjusting the first action score by applying the first customer score from the prime merchant and the second customer score.

In some embodiments, the final action score does not show the reporting merchant customer score. In some embodiments, applying the policy stack comprises applying multiple risk policies each from a different merchant.

Some embodiments pertain to a computer-readable medium that includes instructions stored thereon that when operated on by the computer cause the computer to perform operations that include receiving an action request the action request describing an action between a prime merchant and a customer using action parameters, the parameters including a customer identifier, a prime merchant identifier, and an amount, applying the prime merchant identifier to a merchant database to obtain a policy stack, the policy stack including a sequence of rules identified with the prime merchant to apply to the action parameters to generate a score, applying the customer identifier to a transactions database to obtain a transaction history for the customer, the customer transaction history comprising records of transactions between the customer and a plurality of different merchants, extracting values from the transaction history for use with the policy stack, applying the rules in accordance with the sequence of rules to the action parameters and the values of the customer transaction history at a decision engine, the decision engine generating a first action score, applying the customer identifier to the merchant database to obtain a customer score from the prime merchant, the customer score being generated by the prime merchant for the customer, adjusting the first action score by applying the customer score to the first action score to generate a final action score, and notifying the prime merchant of the final action score to conditionally execute the requested action based on the final action score.

Some embodiments pertain to an apparatus that includes a merchant database comprising a policy stack for each of a plurality of merchants, each policy stack including a sequence of rules identified with the respective merchant to apply to action parameters to generate a score, a transactions database comprising a transaction history for each of a plurality of customers, each transaction history having records of transactions between the customer and a plurality of different merchants, a decision engine to receive an action request, the action request describing an action between a prime merchant and a customer using action parameters, the parameters including a customer identifier, a prime merchant identifier, and an amount, to apply the prime merchant identifier to the merchant database to obtain a policy stack, the policy stack including a sequence of rules identified with the prime merchant to apply to the action parameters to generate a score, to apply the customer identifier to the transactions database to obtain a transaction history for the customer, the customer transaction history comprising records of transactions between the customer and a plurality of different merchants, to extract values from the transaction history for use with the policy stack, to apply the rules in accordance with the sequence of rules to the action parameters and the values of the customer transaction history, the decision engine generating a first action score, to apply the customer identifier to the merchant database to obtain a customer score from the prime merchant, the customer score being generated by the prime merchant for the customer, and to adjust the first action score at the decision engine by applying the customer score to the first action score to generate a final action score, and a communications interface to notify the prime merchant of the final action score to conditionally execute the requested action based on the final action score.

In some embodiments, the merchant database is configured as a content addressable memory and wherein the prime merchant identifier is applied as content to obtain the policy stack from the content addressable memory. In some embodiments, the transactions database comprises records of reports of transactions from reporting merchants other than the prime merchant and wherein the transaction parameters further comprise an amount, a form of payment, parties to the transaction, and a rating as successful or unsuccessful.

In the present description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In the present description, the term “merchant” and “prime merchant” are not limited to entities that directly sell goods/services. For example, a merchant may be a loan service, collections service, money transfer service, bill payment service, bank deposit service, credit union, etc. A payment processor may, in some embodiments, act on behalf of a merchant, for example. The terms “customer,” and “user” are used interchangeably herein. However, the use of the systems and methods presented is not limited to sale/purchase orders between a seller and a buyer. The systems and methods presented may be used to facilitate transactions or orders between: two individuals, an individual and a business, two businesses, etc. The systems and methods presented may also be used to facilitate transactions or orders between any two parties that have a pre-existing relationship or obligation(s).

The terms “point-of-sale,” “point-of-sale terminal,” “POS,” “POS terminal,” and “point-of-payment” may include the actual terminal where payment is presented and received (e.g., the cash register), or may include the POS back office or any entity controlling one or more of the actual terminals. An “order” or “action request” may refer to a representation in a payment processor system, created in response to a request by a merchant, of the merchant product or service that is to be paid for. This may include information such as for how long in time payments should be accepted, as well as a reference to any pricing plan or economic understanding associated with each payment that may be accepted against that order. A “ticket identifier” may refer to information which references an order in a payment processor system, for example.

The figures, individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between merchant, service provider, and POS terminal are performed via an automated computer-based system, such as an application program interface. Further, not all of the individual processes or sub-processes described are necessary for implementing the systems and methods described herein. As such, the embodiments presented in the figures are not intended to be limiting.

The foregoing description of the invention has been presented for purposes of illustration and description. It is not intended to be exhaustive or to limit the invention to the precise forms disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. For example, embodiments of the present invention may be applied to many different types of databases, systems, and application programs. Moreover, features of one embodiment may be incorporated into other embodiments, even where those features are not described together in a single embodiment within the present document.

It is to be appreciated that the Detailed Description section, and not the Title and Abstract sections, is intended to be used to interpret the claims. The Title and Abstract sections may set forth one or more, but not all embodiments of the present invention as contemplated by the inventor(s), and thus, are not intended to limit the present invention and the appended claims in any way. Although this disclosure describes illustrative embodiments of the invention in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

What is claimed is:

1. A method comprising:
receiving an action request at a service provider, the action request describing an action between a prime merchant and a customer using action parameters, the parameters including a customer identifier, a prime merchant identifier, and an amount;
applying the prime merchant identifier to a merchant database to obtain a policy stack, the policy stack including a sequence of rules identified with the prime merchant to apply to the action parameters to generate a score;
applying the customer identifier to a transactions database to obtain a transaction history for the customer, the customer transaction history comprising records of transactions between the customer and a plurality of different merchants;
extracting values from the transaction history for use with the policy stack;
applying the rules in accordance with the sequence of rules to the action parameters and the values of the customer transaction history at a decision engine of the service provider, the decision engine generating a first action score;
applying the customer identifier to the merchant database to obtain a customer score from the prime merchant, the customer score being generated by the prime merchant for the customer;
adjusting the first action score at the decision engine by applying the customer score to the first action score to generate a final action score; and
notifying the prime merchant of the final action score to conditionally execute the requested action based on the final action score.

2. The method of claim 1, further comprising applying the customer identifier to the merchant database to obtain a sequence of indices for the sequence of rules and wherein applying the rules comprises applying an associated index to each rule to conditionally disable the associated rules.

3. The method of claim 1, wherein the merchant database is configured as a content addressable memory and wherein applying the prime merchant identifier comprises applying the prime merchant identifier as content to obtain the policy stack from the content addressable memory.

4. The method of claim 1, wherein the records of transactions comprise an amount, a form of payment, parties to the transaction, and a rating as successful or unsuccessful.

5. The method of claim 1, wherein the transactions database comprises records generated from reports of transactions from reporting merchants other than the prime merchant.

6. The method of claim 1, wherein the action parameters further comprise a form of payment, wherein retrieving the policy stack comprises retrieving a policy stack for the form of payment of the action.

7. The method of claim 1, wherein the customer score is associated only with the customer.

8. The method of claim 1, wherein the customer score is associated with a class of customers.

9. The method of claim 1, wherein the final action score has either a first value to approve the action or a second value to reject the action.

10. The method of claim 9, further comprising alternately executing or not executing the action between the customer and the merchant by the service provider in response to the final action score.

11. The method of claim 1, further comprising storing the action as a record in the transactions database.

12. The method of claim 1, further comprising augmenting the transactions database by processing payments of a plurality of customers, each with at least one merchant, and recording a payment history of the plurality of customers.

13. The method of claim 12, further comprising augmenting the transactions database by correlating transaction data to associate transactions with individual customers.

14. The method of claim 1, further comprising receiving a second customer score from a reporting merchant and wherein adjusting the first action score comprises adjusting the first action score by applying the first customer score from the prime merchant and the second customer score.

15. The method of claim 1, wherein the final action score does not show the reporting merchant customer score.

16. The method of claim 1, wherein applying the policy stack comprises applying multiple risk policies each from a different merchant.

17. A computer-readable medium comprising instructions stored thereon that when operated on by the computer cause the computer to perform operations comprising:
receiving an action request the action request describing an action between a prime merchant and a customer using action parameters, the parameters including a customer identifier, a prime merchant identifier, and an amount;
applying the prime merchant identifier to a merchant database to obtain a policy stack, the policy stack including a sequence of rules identified with the prime merchant to apply to the action parameters to generate a score;
applying the customer identifier to a transactions database to obtain a transaction history for the customer, the customer transaction history comprising records of transactions between the customer and a plurality of different merchants;
extracting values from the transaction history for use with the policy stack;
applying the rules in accordance with the sequence of rules to the action parameters and the values of the customer transaction history at a decision engine, the decision engine generating a first action score;
applying the customer identifier to the merchant database to obtain a customer score from the prime merchant, the customer score being generated by the prime merchant for the customer;
adjusting the first action score by applying the customer score to the first action score to generate a final action score; and
notifying the prime merchant of the final action score to conditionally execute the requested action based on the final action score.

18. An apparatus comprising:
a merchant database comprising a policy stack for each of a plurality of merchants, each policy stack including a sequence of rules identified with the respective merchant to apply to action parameters to generate a score;
a transactions database comprising a transaction history for each of a plurality of customers, each transaction history having records of transactions between the customer and a plurality of different merchants;
a decision engine:
to receive an action request, the action request describing an action between a prime merchant and a customer using action parameters, the parameters including a customer identifier, a prime merchant identifier, and an amount;
to apply the prime merchant identifier to the merchant database to obtain a policy stack, the policy stack including a sequence of rules identified with the prime merchant to apply to the action parameters to generate a score;
to apply the customer identifier to the transactions database to obtain a transaction history for the customer, the customer transaction history comprising records of transactions between the customer and a plurality of different merchants;
to extract values from the transaction history for use with the policy stack;
to apply the rules in accordance with the sequence of rules to the action parameters and the values of the customer transaction history, the decision engine generating a first action score;
to apply the customer identifier to the merchant database to obtain a customer score from the prime merchant, the customer score being generated by the prime merchant for the customer; and
to adjust the first action score at the decision engine by applying the customer score to the first action score to generate a final action score; and
a communications interface to notify the prime merchant of the final action score to conditionally execute the requested action based on the final action score.

19. The apparatus of claim 18, wherein the merchant database is configured as a content addressable memory and wherein the prime merchant identifier is applied as content to obtain the policy stack from the content addressable memory.

20. The apparatus of claim 18, wherein the transactions database comprises records of reports of transactions from reporting merchants other than the prime merchant and wherein the transaction parameters further comprise an amount, a form of payment, parties to the transaction, and a rating as successful or unsuccessful.
